(19) United States
(12) Patent Application Publication
(10) Pub. No.: US 2025/0244995 A1
(43) Pub. Date: Jul. 31, 2025

(54) SYSTEMS AND METHODS FOR UPGRADING UNCONFIGURED NODES, INCLUDING EXAMPLES OF HEALTH MONITORING AND PARALLEL UPGRADES

(71) Applicant: Nutanix, Inc., San Jose, CA (US)

(72) Inventors: Monica Adusumilli, Rajahmundry (IN); Kumar Sidhartha, Bangalore (IN); Manish Sharma, Bangalore (IN); Rishi Kumar, Bangalore (IN); Toms Varghese, Thiruvalla (IN)

(21) Appl. No.: 18/671,838

(22) Filed: May 22, 2024

(30) Foreign Application Priority Data
Jan. 31, 2024 (IN) 202411006340

(51) Int. Cl. G06F 8/65

(52) U.S. Cl. CPC G06F 8/65

(57) ABSTRACT

A system and method for upgrading an unconfigured computing node that includes registering the unconfigured node with a server, the unconfigured node having a client process for upgrading the unconfigured node including and a firmware component; receiving a trigger indication, from the server, of an upgrade of the firmware component on the unconfigured node, including receiving an address for upgrade information for the unconfigured node; obtaining an upgrade image associated with the upgrade; and imaging the firmware component of the unconfigured node using the upgrade image. Upgrading one or more other firmware components on one or more other unconfigured nodes, in parallel, and monitoring a health status of the unconfigured node and/or the one or more other unconfigured nodes, prior to, during, and/or after the firmware upgrades, are also described.

### CROSS-REFERENCE TO RELATED APPLICATION(S)

This application claims priority to India application No. 202411006340 filed Jan. 31, 2024, which is incorporated herein by reference, in its entirety, for any purpose.

### TECHNICAL FIELD

The present disclosure relates generally to systems and methods for upgrading an unconfigured computing node, including an upgrade device. Examples of using the upgrade device to register the unconfigured computing node with a server, receive an upgrade image associated with an upgrade for a firmware component on the unconfigured computing node, and upgrade the firmware component on the unconfigured node using the upgrade image are described. Examples of upgrading one or more other firmware components on one or more other unconfigured nodes, in parallel, are also described. Examples of monitoring a health status of the unconfigured node and/or the one or more other unconfigured nodes, prior to, during, and/or after the firmware upgrades are also described.

### BACKGROUND

In traditional systems, upgrading firmware components (e.g., associated with hardware) on a computing node (e.g., a remote node) often requires the computing node to have already joined a plurality of other nodes (e.g., a node cluster). In these traditional systems, upgrading firmware on the computing node often starts by establishing a network connection between a coordinating node and the computing node. Next, an imaging tool is deployed on the coordinating node. The tool is utilized to remotely access and control the computing node, allowing for image deployment, firmware and/or software configuration, and system customization. So far, for the computing node to obtain and upgrade its firmware components, the computing node would need to have already joined or formed a cluster with one or more other computing nodes, and would also depend on another coordinating node, a standalone virtual machine, or some other management system (e.g., a lifecycle manager) to provide the firmware and/or software upgrades. In some traditional systems, customers and/or users and/or administrators are forced to manually upgrade firmware and/or software of a computing node on site and/or on premise. With speed at which firmware and/or software is improved to combat real world issues (e.g., security and/or data integrity issues, processing improvements, etc.), and lack of a “Day Zero” upgrade capability for computing nodes prior to configuration, the flexibility that node deployment with the latest firmware and/or software updates would offer would be immense.

### BRIEF DESCRIPTION OF THE DRAWINGS

Reference is now made to the following descriptions taken in conjunction with the accompanying drawings, in which:

FIG. 1 is a schematic illustration of a system 100 for upgrading an unconfigured computing node, prior to the unconfigured node joining a node cluster, arranged in accordance with examples described herein;

FIG. 2 depicts an example sequence diagram 200 for upgrading an unconfigured computing node, arranged in accordance with examples described herein;

FIG. 3 is a schematic illustration of a distributed computing system 300 including an unconfigured computing node that has been upgraded and is part of a single-node cluster, arranged in accordance with examples described herein;

FIG. 4 is a schematic illustration of a distributed computing system 400 including an unconfigured computing node that has been upgraded and is part of a multi-node cluster, arranged in accordance with examples described herein;

FIG. 5A is a flow diagram of a method 500 for upgrading an unconfigured computing node, arranged in accordance with examples described herein;

FIG. 5B is a flow diagram of a method 520 for upgrading an unconfigured computing node, arranged in accordance with examples described herein; and

FIG. 6 is a schematic illustration of components of a computing node 600, arranged in accordance with examples described herein.

### DETAILED DESCRIPTION

Certain details are set forth herein to provide an understanding of described embodiments of technology. However, other examples may be practiced without various ones of these particular details. In some instances, well-known computing system components, virtualization components, circuits, control signals, timing protocols, and/or software operations have not been shown in detail in order to avoid unnecessarily obscuring the described embodiments. Other embodiments may be utilized, and other changes may be made, without departing from the spirit or scope of the subject matter presented herein. The various embodiments disclosed herein are not necessarily mutually exclusive, as some disclosed embodiments can be combined with one or more other disclosed embodiments to form new embodiments.

Due in part to drawbacks of traditional systems described herein, it may be desirable to facilitate the upgrade of one or more firmware and/or software of an unconfigured computing node without the need for the unconfigured computing node to have joined a plurality of other nodes (e.g., a node cluster) prior to upgrade, and without the assistance of a coordinating node, an orchestrator, a standalone virtual machine, or the like. As used herein, an unconfigured computing node may refer to a node which has not had instances of distributed services installed on the node for participation in a node cluster. In some examples, an unconfigured computing node may refer to a node or a server which is not part of a cluster yet. Once upgraded, the configured computing node (e.g., the remote node) may join a cluster of nodes. For example, one or more virtual machines on the node may be registered with a cluster service on another node such that the remote node may function as part of a distributed system implemented using the cluster of nodes. Generally, a cluster herein refers to a plurality of computing nodes that may work together to provide high availability, reliability, and/or scalability. A cluster of computing nodes may provide a distributed system where instances of a distributed service may be hosted on each of the plurality of computing nodes. If one computing node and/or instance of the distributed service becomes unavailable, another instance of the distributed application resident on another computing node may take over for operations of the instance that is unavailable. In some examples, one computing node and/or instance is a leader node which may coordinate operation of other computing nodes and/or instances in the cluster. Accordingly, in some examples, nodes which are members of a cluster may have an identification of the node stored in a cluster identification storage. The cluster identification storage may be implemented, for example, as a database at a leader node, and/or as a distributed database stored among the nodes of the cluster. The cluster identification storage may be used by nodes in the cluster to identify nodes which may be available to provide services for the cluster.

One or more of the drawbacks of traditional systems may include that the upgrade of firmware and/or software moves rapidly in response to real world issues (e.g., security, integrity, etc.). In this regard, computing nodes shipped to a customer and/or user and/or an administrator with the latest and/or best firmware available at the point of deployment from a factory might already be outdated before the computing node gets installed (e.g., racked) and configured. Further, computing nodes may be sitting at a customer and/or user and/or administrator depot for an undefined amount of time, including delays, before deployment. Computing node cluster expansion and/or computing node replacement activity may also include selecting computing nodes for expansion and/or replacement that have outdated and/or vulnerable firmware and/or software. Further still, when a computing node with outdated and/or vulnerable firmware and/or software is installed, often the customer and/or user and/or administrator will receive an outdated firmware alert as soon as the computing node is running and/or a cluster of computing nodes is created. Here, the customer and/or user and/or administrator may be forced to spin-up another maintenance window to upgrade the outdated and/or vulnerable firmware and/or software as soon as the computing node goes live. This may often result in an undesirable customer experience, as well as live computing nodes that are vulnerable. Additional drawbacks of traditional systems may include, but are not limited to, the lack of a unified way of handling inventory and upgrades for computing nodes that are not configured as part of a cluster, as well as the challenge of coordinating upgrades for the firmware components of each unconfigured computing node.

The present disclosure relates generally to systems and methods for upgrading firmware and/or software (e.g., relating to, associated with, and/or corresponding to one or more hardware components) of an unconfigured computing node, including an upgrade device. Examples of using the upgrade device to register the unconfigured computing node with a server, receive an upgrade image associated with an upgrade for a firmware component on the unconfigured computing node, and upgrading the firmware component on the unconfigured node using the upgrade image are described. Examples of upgrading one or more other firmware components on one or more other unconfigured nodes, in parallel, are also described. Examples of monitoring a health status of the unconfigured node and/or the one or more other unconfigured nodes, prior to, during, and/or after the firmware upgrades are also described. An upgrade device, as used herein, in some examples, may refer to a component (e.g., hardware and/or software) that may be configured to perform one or more upgrade operations as described throughout.

As should be appreciated, there are a number of technical advantages and benefits associated with the systems and methods described throughout. Examples of systems and methods described herein may (1) minimize and/or eliminate the need for a coordinating node (e.g., a coordinating remote node), thereby removing (e.g., minimizing) dependency of remote nodes on each other, (2) reduce the time taken for firmware and/or software upgrades once a cluster is created, (3) reduce and/or minimize the number of errors during the upgrade process, (4) support the creation of a cluster with one or more nodes that are already upgraded and/or up to date, and (5) enable a server to support the upgrade of unconfigured nodes by acting, in some examples, as an intent manager for installation of new software and/or firmware upgrades of one or more hardware components of one or more unconfigured nodes. Systems and methods described herein also discuss health status monitoring. Systems and methods described herein also discuss parallel firmware and/or software upgrade of one or more hardware components of a computing node, and/or parallel firmware and/or software upgrade of one or more hardware components of more than one computing node. Additional technical advantages and benefits associated with the systems and methods described herein include, but are not limited to, the upgrading and/or updating of a firmware and/or software component of an unconfigured computing node that can be performed as part of an imaging processes (e.g., a node imaging process), instead of, in some examples, doing a firmware upgrade separate from an imaging process, as two distinct steps. Such an advantage provides at least time saving benefits when it comes to upgrading and imaging nodes (e.g., unconfigured computing nodes).

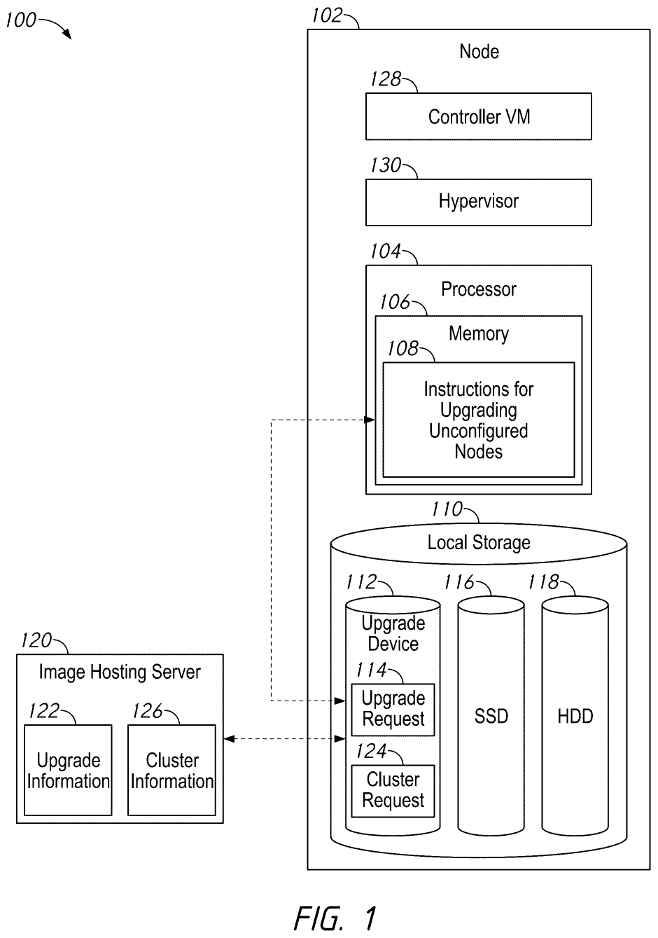

Turning now to FIG. 1, FIG. 1 is a schematic illustration of a system 100 for upgrading an unconfigured computing node, prior to the unconfigured node joining a node cluster, arranged in accordance with examples described herein.

As described herein, system 100 of FIG. 1 generally includes a computing node 102 (e.g., an unconfigured node) and image hosting server 120 (e.g., location that contains upgrade information, cluster information, address information, etc.). Computing node 102 may include processor 104. Processor 104 may include memory 106 and executable instructions 108 for upgrading unconfigured nodes. Computing node 102 may include local storage 110, which may include upgrade device 112, solid state drive (SSD) 116, and hard disk drive (HDD) 118. Upgrade device 112 may include upgrade request 114 and cluster request 124. Image hosting server 120 may include upgrade information 122 and cluster information 126. Computing node 102 may further include one or more controller virtual machines (controller VMs), such as controller VM 128 and one or more hypervisors, such as hypervisor 130.

In some examples, computing node 102 in system 100 may be an unconfigured computing node that has yet to be deployed to a location (e.g., a remote location). In some examples, computing node 102 in system 100 may have been deployed to a location (e.g., a remote location), but has yet to join and/or create and/or otherwise become a part of a cluster (e.g., a multi-node cluster, etc.). For example, an unconfigured node may refer to a node which has not had its node identification included in cluster identification storage. Accordingly, nodes in the cluster are not communicating with the unconfigured node to provide resiliency, redundancy, or distributed computing functionality. An unconfigured node may refer to a node which has not had instances of distributed services installed on the node for participation in a node cluster. In some examples, computing node 102 in system 100 may be a computing node with one or more firmware and/or software components. In some examples, the one or more firmware and/or software components may be associated with and/or may correspond to one or more respective hardware components of computing node 102. In some examples, the firmware and/or software of computing node 102 may be outdated and need upgrading. In some examples, computing node 102 may be a remote node.

As should be appreciated, the components shown in FIG. 1 are exemplary. Additional, fewer, and/or alternative components may be used in other examples. Further, while a controller VM and a hypervisor are shown in FIG. 1, it should be understood that the hypervisor may, in some examples, perform the functions described herein as being performed by the controller VM. In some examples, one or more containers may be used to implement the controller VM.

Computing node 102 may generally implement the upgrade of an unconfigured computing node functionality as described herein. Examples of computing node 102 described herein may include, for example, a server computer, a laptop computer, a desktop computer, a tablet computer, a smart phone, or any other type of computing device. In operation, computing node 102 may be in a physically remote location (e.g., remote from other computing nodes, remote from required IT personnel, or at a remote office, branch office (ROBO) site, etc.). In some examples, computing node 102 may be in a physically remote location, without the presence of other computing nodes. In some examples, computing node 102 may be in a physically remote location with one or more other computing nodes. In some examples, computing node 102 may be located in a remote location and in a state that is prior to having its firmware upgraded via a firmware upgrade image obtained from a server (e.g., an image hosting server).

Computing node 102, as described herein, may include one or more processors, such as processor 104. Any kind and/or number of processors may be present, including one or more central processing unit(s) (CPUs); graphics processing units (GPUs); other computer processors, mobile processors, digital signal processors (DSPs), microprocessors, computer chips; and/or other processing units configured to execute the upgrading of firmware and/or software of unconfigured node instructions, such as executable instructions 108 for upgrading unconfigured nodes.

Computing node 102 as described herein, may further include memory, such as memory 106. Any type or kind of memory may be present (e.g., read-only memory (ROM), random access memory (RAM), SSD, and secure digital card (SD card)). While a single box is depicted as memory 106, any number of memory devices may be present. The memory 106 may be in communication (e.g., electrically connected, electrically coupled, communicatively coupled, etc.) to processor 104. Memory 106, as described herein, may store executable instructions for execution by the processor 104, such as executable instructions 108 for upgrading unconfigured nodes.

Computing node 102, as described herein, may include local storage 110. The local storage 110 may include, for example, one or more solid state drives (SSD 116), one or more hard disk drives (HDD 118), and/or one or more upgrade devices, such as upgrade device 112. As described herein, upgrade device 112 may be used to perform one or more of the unconfigured node upgrade operations described herein. In some examples, upgrade device 112 may include upgrade request 114, and may further include cluster request 124. In some examples, upgrade request 114 may be used to request information about a firmware and/or a software upgrade from a server, such as image hosting server 120. In some examples, cluster request 124 may be used to request that the unconfigured node join and/or create a cluster (e.g., after the upgrade of the firmware and/or software).

System 100, as described herein, may further include an image hosting server, such as image hosting server 120. Image hosting server 120 may be communicatively coupled to computing node 102, and may be accessible to one or more components of computing node 102, such as, for example, upgrade device 112. In some examples, image hosting server 120 may be or include any form of memory and/or storage, such as an SSD, HDD, NVMe, and the like, configured to store data and or metadata, such as operating system data, upgrade information and/or upgrade imaging data (e.g., an upgrade image) associated with one or more upgrades and/or updates for one or more firmware and/or software components, cluster creation information and/or data, address information for upgrade information for one or more unconfigured computing nodes, and/or any other information relevant to the upgrade of unconfigured computing nodes. In some examples, image hosting server 120 may include upgrade information for one or more firmware and/or software components. In some examples, the one or more firmware and/or software components may correspond to and/or be associated with one or more hardware components, such as hardware components hosted on one or more unconfigured computing nodes, such as computing node 102.

In some examples, while not shown, computing node 102 may include one or more operating systems (e.g., a computing node operating system). In some examples, the one or more operating systems may be a NUTANIX® operating system comprising one or more controller VMs, and/or one or more hypervisors. As should be appreciated, the one or more operating systems encompass any number and type of operating system, including operating systems with different architectures, and suitable for being used to image one or more of computing nodes, such as computing nodes described herein.

In some examples, image hosting server 120 may be located remote from computing node 102. In some examples, image hosting server 120 may be located local to computing node 102. In some examples, the location of the image hosting server 120 may be known to computing node 102 by way of upgrade device 112. For example, the location of image hosting server 120 may comprise a URL using one or more schemes, including Hypertext Transfer Protocol (HTTP), Hypertext Transfer Protocol Secure (HTTPS), Network File System (NFS), Server Message Block (SMB), or combinations thereof. In some examples, the location of the image hosting server may be specified in a dynamic host configuration protocol (DHCP) configuration. In some examples, the location of the image hosting server may be specified in a JavaScript object notation (JSON) file. In some examples, the DHCP configuration and/or the JSON file may be provided to computing node 102.

In some examples, one or more components of computing node 102 may access image hosting server 120 without the need for authentication (e.g., client, user, administrator, etc., authentication). In some examples, one or more components of computing node 102 may access image hosting server 120 to register itself with image hosting server 120. In some examples, one or more components of computing node 102 may access image hosting server 120 to transmit an identity of one or more firmware and/or software components hosted on and/or included in computing node 102. In some examples, one or more components of computing node 102 may access image hosting server 120 responsive to an indication (e.g., a trigger indication) of an upgrade of one or more firmware and/or software components. In some examples, the indication may include and/or comprise an address for upgrade information for an unconfigured computing node (e.g., computing node 102). In some examples, one or more components of computing node 102 may access the address provided by an image hosting server, such as image hosting server 120. In some examples, the address to obtain the upgrade information for the unconfigured node may be located at image hosting server 120. In some examples, the address to obtain the upgrade information for the unconfigured node may be located at another image hosting server, not shown. In some examples, the address to obtain the upgrade information for the unconfigured node may be located at other locations not shown.

In some examples, computing node 102 may include one or more controller VMs, such as controller VM 128 and one or more hypervisors, such as hypervisor 130. While a controller VM and a hypervisor are shown in FIG. 1, it should be understood that the hypervisor may in some examples perform the functions described herein as being performed by the controller VM. In some examples, one or more containers may be used to implement the controller VM.

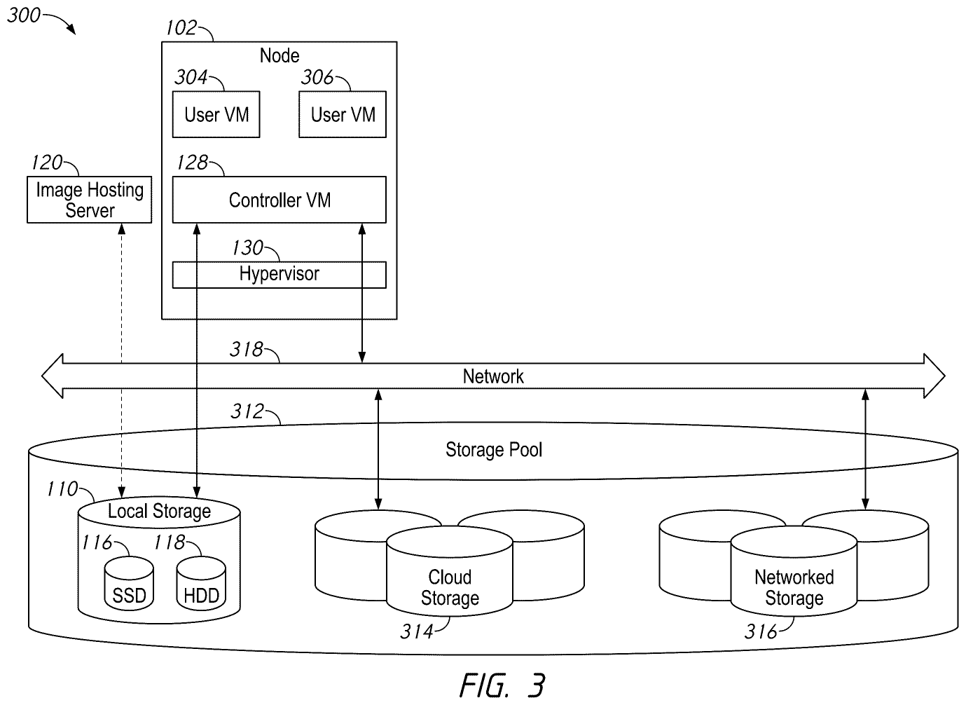

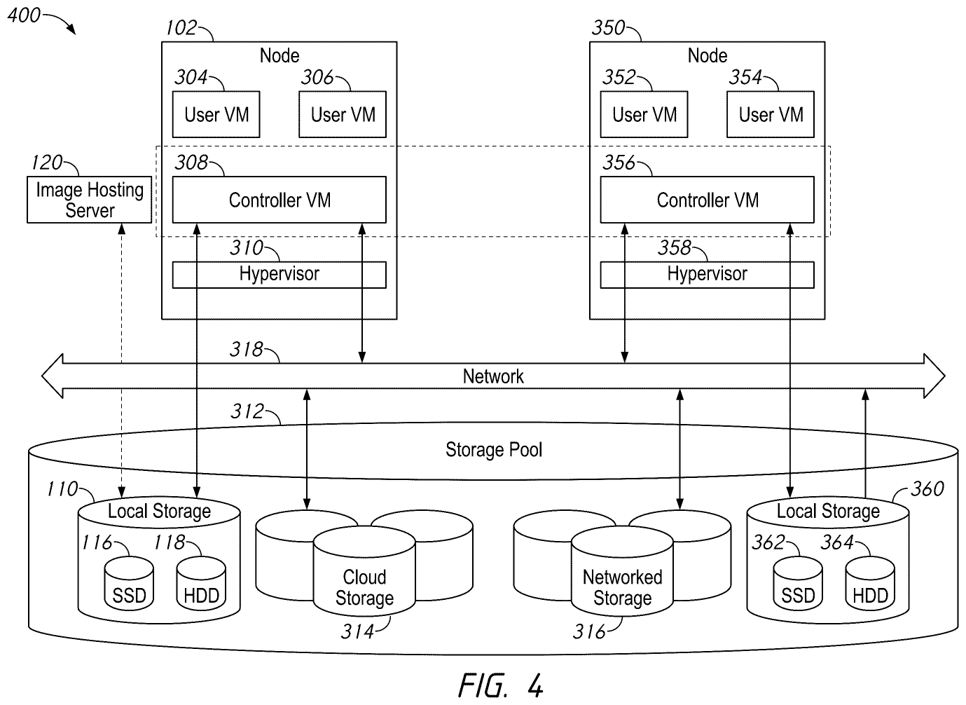

Examples of controller VMs (CVMs), as described herein, may execute a variety of software and/or may serve the input/output (I/O) operations for the additional and/or alternative components of a computing node, such as computing node 102. In some examples, controller VMs, as described herein, may execute a variety of software and/or may serve the I/O operations on hypervisor 130 of FIG. 1. With respect to FIGS. 3 and 4, in some examples, controller VMs, as described herein, may execute a variety of software and/or may serve the I/O operations for user VMs running on a computing node once upgraded, such as computing node 102 and/or computing node 350 of FIGS. 3 and 4. In some examples, a small computer system interface (SCSI) controller, which may manage SSD and/or HDD devices described herein (such as SSD 116 and HDD 118, of FIG. 1), may be directly passed to the CVM, e.g., leveraging VM-Direct Path. In the case of Hyper-V, the storage devices may be passed through to the CVM. The controller VM 128 may also manage the upgrading and/or updating of one or more firmware and/or software components of one or more computing nodes, such as computing node 102, in some examples. After a firmware and/or software component of computing node 102 is upgraded and/or updated via an upgrade image, computing node 102 may be configured to join a single-node cluster and/or a multi-node cluster (and/or join a group/plurality of other computing nodes).

Operationally, computing node 102 as described herein may be configured to execute instructions 108 for upgrading unconfigured nodes. In some examples, computing node 102 may, by executing instructions 108 for upgrading unconfigured nodes, register unconfigured computing node 102 with a server, such as image hosting server 120. In some examples, computing node 102 may include, comprise, or have a client process for upgrading the unconfigured node. In some examples, computing node 102 may include, comprise, or have a firmware and/or a software component. As described herein, the firmware and/or software component may be associated with and/or correspond to a hardware component of a computing node, such as computing node 102.

In some examples, an unconfigured computing node, such as computing node 102, begins the upgrade process by registering with a server (e.g., image hosting server 120), and transmitting an identity of one or more firmware and/or software components to the server. In some examples, computing node 102 may register with the server and/or transmit the identity of one or more firmware and/or software components even when it may not yet be deployed. In some examples, computing node 102 may register with the server and/or transmit the identity of one or more firmware and/or software components when it may be deployed, but not yet installed and/or racked. In some examples, computing node 102 may register with the server and/or transmit the identity of one or more firmware and/or software components when it is not part of a cluster (e.g., a single-node cluster and/or a multi-node cluster) and/or not part of a plurality of nodes. As used herein, and in some examples, deployment may refer to an unconfigured computing node that has yet to be sent to a location (e.g., a remote location, etc.). In some examples, deployment may refer to an unconfigured computing node that has yet to join and/or create and/or otherwise become a part of a cluster.

Operationally, computing node 102 as described herein may be configured to execute instructions 108 for upgrading unconfigured nodes. In some examples, computing node 102 may, by executing instructions 108 for upgrading unconfigured nodes, transmit from computing node 102 an identity of the firmware component of computing node 102 to a server, such as image hosting server 120. In some examples, computing node 102 may transmit an identity of a single firmware component for the computing node 102. In some examples, computing node 102 may transmit the identities of more than one firmware components for the computing node 102. In some examples, computing node 102 may transmit one or more identities for one or more software components of the computing node 102. In some examples, computing node 102 may, by executing instructions 108 for upgrading unconfigured nodes, receive an indication of an intent to create a node cluster (e.g., a single-node cluster, a multi-node cluster, a plurality of nodes, etc.), from image hosting server 120. In some examples, computing node 102 may, by executing instructions 108 for upgrading unconfigured nodes, receive an indication of an intent to join a pre-existing cluster of nodes (and/or a pre-existing plurality of nodes). In some examples, computing node 102 may, by executing instructions 108 for upgrading unconfigured nodes, transmit an identity of the firmware component of computing node 102 to image hosting server 120 using upgrade request 114.

In some examples, the firmware and/or the software described herein may be associated with and/or correspond to one or more hardware components of computing node 102. In some examples, the identity of the firmware and/or the software may include versioning information, such as a version name, a version number, and the like. In some examples, the software and/or firmware may include basic input/output system (BIOS) firmware, ROM BIOS, PC BIOS, and/or other firmware and/or software used, in some examples, to operate and/or control hardware components of computing nodes, such as computing node 102.

Operationally, computing node 102 as described herein may be configured to execute instructions 108 for upgrading unconfigured nodes. In some examples, computing node 102 may, by executing instructions 108 for upgrading unconfigured nodes, receive a trigger indication from a server, such as image hosting server 120, of an upgrade of the firmware component and/or the software for an unconfigured computing node, such as computing node 102. In some examples, the trigger indication received from image hosting server 120 may include an address for upgrade information for the unconfigured node, such as computing node 102. The trigger indication may be implemented using a message, such as one or more packets, provided from the image hosting server 120. The image hosting server 120 may provide a trigger indication when an updated version of a firmware component and/or software for an unconfigured computing node is available. For example, the image hosting server 120 may access stored data regarding the identity of firmware components and/or software present on an unconfigured node. When an upgrade firmware component and/or software is available at the image hosting server 120, the image hosting server may analyze the identity of firmware components and/or software present on unconfigured nodes and transmit a trigger indication to nodes having the firmware component and/or software for which an upgrade is available.

Operationally, computing node 102 as described herein may be configured to execute instructions 108 for upgrading unconfigured nodes. In some examples, computing node 102 may, by executing instructions 108 for upgrading unconfigured nodes, access the address for upgrade information for the unconfigured computing node, such as computing node 102. In some examples, computing node 102 may access the address using the client process for upgrading the unconfigured node. In some examples, computing node 102 may access the address using the client process responsive to the trigger indication. In some examples, the location of the upgrade information for the unconfigured node, provided by the address, may be located at image hosting server 120. In some examples, the location to obtain the upgrade information for the unconfigured node provided by the address may be located at another image hosting server, not shown. In some examples, the location to obtain the upgrade information for the unconfigured node provided by the address may be located at other locations not shown. In some examples, computing node 102 may, by executing instructions 108 for upgrading unconfigured nodes, and responsive to receiving the trigger indication, from a server, such as image hosting server 120, obtain dependency logic. In some examples, the dependency logic may be obtained by computing node 102 from a server, such as image hosting server 120. In some examples, dependency logic may be obtained from other servers (not shown), as well as other components of system 100, both shown and not shown. In some examples, computing node 102 may, by executing instructions 108 for upgrading unconfigured nodes, access the address using upgrade request 114. Dependency logic may refer to data and/or instructions which indicate one component is dependent on another. Dependency refers to a relationship between components such that the upgrade of one component may be based on the upgrade of another component. For example, a firmware component of the unconfigured node may not be available for upgrade without first upgrading a related software component of the unconfigured node, or vice versa. In some examples, one firmware component of the unconfigured node may not be available for upgrade without first upgrading a related, different firmware component of the unconfigured node. Dependency logic may be implemented using a table in some examples including an identification of a firmware and/or software component and associated other firmware and/or software components which affect the upgrade of the identified firmware and/or software component.

Operationally, computing node 102 as described herein may be configured to execute instructions 108 for upgrading unconfigured nodes. In some examples, computing node 102 may, by executing instructions 108 for upgrading unconfigured nodes, execute the dependency logic. In some examples, computing node 102 may execute the dependency logic to identify an upgrade for a firmware component of a computing node, such as computing node 102. In some examples, computing node 102 may execute dependency logic to identify an upgrade for a software component of a computing node, such as computing node 102. In some examples, computing node 102 may execute dependency logic to identify an upgrade for a firmware component and a software component, respectively, of computing node 102. In some examples, computing node 102 may execute dependency logic to identify one or more upgrades for one or more firmware components and/or one or more software components of a computing node, such as computing node 102.

In some examples, the firmware component may be related to and/or associated with a hardware component of computing node 102. In some examples, the software component may be related to and/or associated with a hardware component of computing node 102. Examples of hardware of an unconfigured computing node, such as computing node 102 as described herein, may include, but are not limited to, central processing unit(s) (CPUs), graphics processing unit(s) (GPUS), data processing unit(s) (DPUs), Neural processing unit(s) (NPUs), video processing unit(s) (VPUs), additional and/or other hardware accelerator components, random access memory (RAM), HDDs, SSDs, and other memory management components, as well as additional and/or alternative hardware components.

Operationally, computing node 102 as described herein may be configured to execute instructions 108 for upgrading unconfigured nodes. In some examples, computing node 102 may, by executing instructions 108 for upgrading unconfigured nodes, obtain an upgrade image associated with an upgrade. In some examples, the upgrade image may be associated with an upgrade for firmware of an unconfigured computing node, such as computing node 102. In some examples, the upgrade image may be associated with an upgrade for software of an unconfigured computing node, such as computing node 102. In some examples, computing node 102 may obtain the upgrade image associated with an upgrade via the client process. In some examples, computing node 102 may obtain the upgrade image associated with an upgrade from a server, such as image hosting server 120. In some examples, computing node 102 may obtain the upgrade image associated with an upgrade from image hosting server 120 via upgrade information 122.

Once computing node 102 obtains an upgrade image, computing node 102 may, by executing instructions 108 for upgrading unconfigured nodes, image the firmware component of computing node 102 using the upgrade image, in some examples. In some examples, computing node 102 may image the firmware component of computing node 102 using the upgrade image and via the client process. In some examples, computing node 102 may image the firmware component of computing node 102 via an in-band communication mechanism. In some examples, the in-band communication mechanism may comprise communicating through a virtual network interface card (vNIC) exposed, by a baseboard management controller (BMC), to the operating system installed on the server. In some examples, the vNIC may be exposed, by the BMC, only to the operating system installed on the server. In some examples, the in-band communication may occur using redfish APIs exposed by the BMC through the vNIC. In some examples, additional and/or alternative in-band communication mechanisms maybe used. In some examples, ipmitool may use an open interface or system interface channel as an in-band mechanism.

Operationally, computing node 102 as described herein may be configured to execute instructions 108 for upgrading unconfigured nodes. In some examples, computing node 102 may, by executing instructions 108 for upgrading unconfigured nodes, join (and/or request to join) a cluster. In some examples, computing node 102 may join (and/or request to join) a single-node cluster. In some examples, computing node 102 may join (and/or request to join) a multi-node cluster. In some examples, computing node 102 may join (and/or request to join) a plurality of nodes and/or a node group. In some examples, the cluster, plurality of nodes, and/or node group may comprise one or more other computing nodes (e.g., other remote nodes, other formerly-unconfigured nodes, etc.). In some examples, computing node 102 may join (and/or request to join) a cluster, based at least in part on imaging the firmware component of the unconfigured node using the upgrade image. In some examples, computing node 102 may join (and/or request to join) a cluster, based at least in part on imaging the software component of the unconfigured node using the upgrade image. As should be appreciated, in some examples, imaging the firmware component of the unconfigured node and/or imaging the software component of the unconfigured node may include upgrading the one or more versions of hardware on an unconfigured computing node, such as computing node 102. In some examples, upgrading the one or more versions of hardware on an unconfigured computing node, such as computing node 102, may involve upgrading to the latest available version of firmware and/or software.

Operationally, computing node 102, as described herein, may be configured to, by executing instructions 108 for upgrading unconfigured nodes, monitor the status of the upgrade operations (e.g., the accessing, identifying, obtaining, imaging, etc.). In some examples, computing node 102 may be configured to, by executing instructions 108 for upgrading unconfigured nodes, monitor the status of the upgrade operations using an application programming interface (API). In some examples, the API may be a representational state transfer (REST) API. In some examples, the API may be a remote procedure call (RPC) API. In some examples, the API may be a GraphQL API. In some examples, the API may be a combination of any of the APIs described herein.

As should be appreciated, the API used for monitoring the upgrade operations may be an additional and/or alternative API to those listed herein, each of which is considered to be within the scope of this disclosure. In some examples, computing node 102 (and/or executing instructions 108 for upgrading unconfigured nodes) may not need to invoke an API (such as the APIs described herein) to monitor the status of the upgrade operations. In some examples, one or more APIs may be exposed by a node, such as computing node 102, and APIs, such as the APIs described herein, may be used by one or more external systems (if needed) for monitoring the status of the upgrade operations. In some examples, the status of the upgrade operations may be monitored at one or more time intervals, such as every “x” number of seconds, minutes, etc. As one nonlimiting example, the status of the upgrade operations (including upgrade and/or update progress indications and/or information) may occur every 30 seconds.

As should be appreciated, while a single unconfigured computing node (e.g., computing node 102) is described above as being imaged, additionally and/or alternatively, one or more other unconfigured computing nodes (not shown) in FIG. 1 may also be imaged by a server, such as image hosting server 120.

As a nonlimiting example, a second unconfigured node (not shown) (e.g., a second unconfigured computing node), may be configured to, by executing other instructions for upgrading unconfigured nodes, register, with a server such as image hosting server 120, the second unconfigured node (not shown). In some examples, the second unconfigured node may include a second client process for upgrading the second unconfigured node. In some examples, the second unconfigured node may include a second firmware component. Once the second unconfigured node is registered, and in some examples, the second unconfigured node may be configured to, by executing other instructions for upgrading unconfigured nodes, transmit an identity of the second firmware component to image hosting server 120.

In some examples, the second unconfigured node may be configured to, by executing other instructions for upgrading unconfigured nodes, receive from a server, such as image hosting server 120, a second trigger indication of a second upgrade of the second firmware component on the second unconfigured node. In some examples, the second trigger indication may include a second address for second upgrade information to the second unconfigured node. In some examples, and responsive to the second trigger indication, the second unconfigured node may be configured to, by executing other instructions for upgrading unconfigured nodes, access the second address. In some examples, the second unconfigured node may be configured to access the second address via the second client process. In some examples, the second unconfigured node may be configured to access the second address and obtain a second dependency logic. In some examples, the second unconfigured node may be configured to execute the second dependency logic, by the second client process, to identify a second upgrade for the second firmware component. In some examples, the second unconfigured node may identify a second upgrade of a second software component. In some examples, the second unconfigured node may identify a second upgrade of a firmware component and a second upgrade of a software component of the second unconfigured node.

In some examples, the second unconfigured node may be configured to, by executing other instructions for upgrading unconfigured nodes, obtain, by the second client process, a second upgrade image associated with the second upgrade. In some examples, the second unconfigured node may be configured to, by executing other instructions for upgrading unconfigured nodes, image, by the second client process, the second firmware component of the second unconfigured node using the second upgrade image.

In some examples, computing node 102 may be configured to, by executing instructions 108 for upgrading unconfigured nodes, upgrade computing node 102 with the upgrade image independently from the upgrading one or more other nodes (such as the second unconfigured node) via one or more other upgrade images, and by the one or more other nodes. In some examples, the upgrading of the second firmware component of the second unconfigured node using the second upgrade image (not shown in FIG. 1), and the upgrading of the computing node 102 (e.g., the unconfigured computing node) using the upgrade image, may be performed in parallel. In some examples, the parallel upgrade of computing node 102 and the second unconfigured node may be self-performed by each unconfigured computing node, respectively.

Operationally, computing node 102 as described herein may be configured to execute instructions 108 for upgrading unconfigured nodes. In some examples, computing node 102 may, by executing instructions 108 for upgrading unconfigured nodes, provide health information to a server, such as image hosting server 120. In some examples, a server, such as image hosting server 120 may perform the health check on computing node 102. In some examples, the health check may be performed after computing node 102 registers with image hosting server 120. In some examples, the health check may be performed prior to upgrading one or more firmware and/or software components of computing node 102. In some examples, the health check may be performed during the upgrading process of one or more firmware and/or software components of computing node 102. In some examples, the health check may be performed after upgrading one or more firmware and/or software components of computing node 102.

As should be appreciated, both monitoring of the upgrade operations and performing a health check of an unconfigured node are described herein. In some examples, the monitoring of the upgrade operations and the performance of a health check may be performed separately and/or in parallel. In some examples, the monitoring of the upgrade operations and the performance of a health check may be performed by the same component of system 100, and/or by separate components of system 100. In some examples, the monitoring of the upgrade operations and the performance of a health check may be performed by components of system 100 that are not shown.

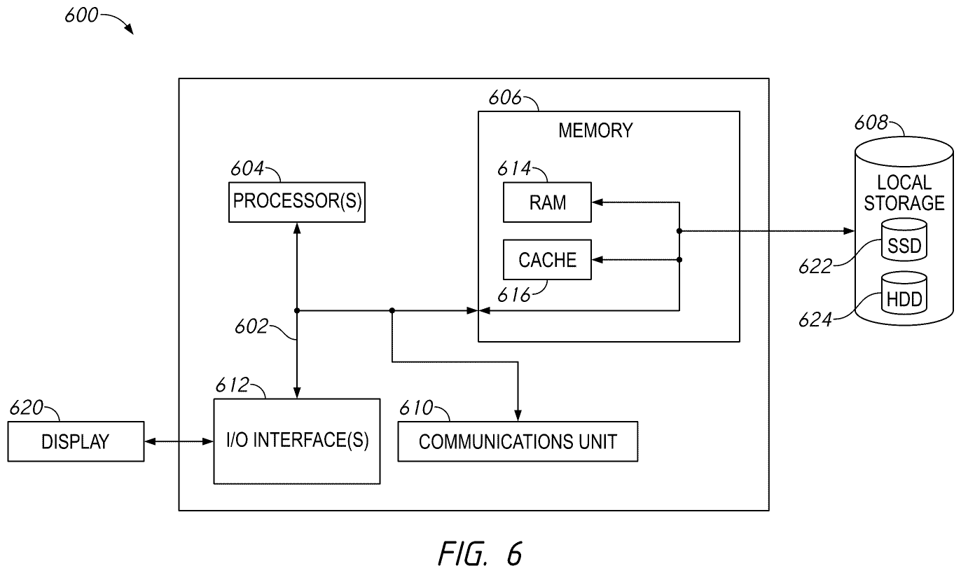

Operationally, computing node 102, as described herein, may be configured to, by executing instructions 108 for upgrading unconfigured nodes, provide (via a display, such as display 620 of FIG. 6) a graphical user interface (GUI) corresponding to and/or associated with the status of the upgrading operations. In some examples, the status provided by computing node 102 may comprise one or more progress updates associated with the upgrade operations. In some examples, the progress updates may be stored and/or presented in a log, such as an event log. In some examples, the one or more progress updates are stored on one or more files (e.g., log files, log messages, etc.) that may be accessible via one or more APIs described herein. In some examples, one or more log files, log messages, and the like, may comprise the one or more progress updates, and may be included in the event log. While one or more log files and/or log messages are described as comprising the one or more progress updates, it should be appreciated that the one or more progress updates may be stored and/or provided in a number of formats and/or methods. In some examples, the API may return the progress updates and/or the status of the upgrade operations in one or more formats, including but not limited to, a JavaScript Object Notation (JSON) format. In some examples, the progress updates can be provided directly as a response to an API request as well as and/or instead of sharing it via a file.

Operationally, computing node 102, as described herein, may be configured to, by executing instructions 108 for upgrading unconfigured nodes, provide (via a display, such as display 620 of FIG. 6) a graphical user interface (GUI) corresponding to and/or associated with a health check for one or more unconfigured nodes prior to, during, and/or after the upgrade process. In some examples, the status provided by computing node 102 may comprise one or more health check information and/or data updates associated with the health of one or more unconfigured node operations. In some examples, the health check information and/or data updates may be stored and/or presented in a log, such as an event log. In some examples, the one or more health check information and/or data updates are stored on one or more files (e.g., log files, log messages, etc.) that may be accessible via one or more APIs described herein. In some examples, one or more log files, log messages, and the like may comprise the one or more health check information and/or data updates, and may be included in the event log. While one or more log files and/or log messages are described as comprising the one or more health check information and/or data updates, it should be appreciated that the one or more health check information and/or data updates may be stored and/or provided in a number of formats and/or methods. In some examples, the API may return the health check information and/or data updates and/or the status of the upgrade operations in one or more formats, including but not limited to, a JavaScript Object Notation (JSON) format. In some examples, the health check information and/or data updates can be provided directly as a response to an API request as well as and/or instead of sharing it via a file.

Operationally, computing node 102, as described herein, may be configured to operate without joining one or more other computing nodes upon completion of upgrading one or more firmware and/or software components on computing node 102. For example, upon completion of upgrading a firmware component of computing node 102, computing node 102 may be configured to join a single-node cluster, where the single node is the recently upgraded computing node 102. In some examples, upon completion of upgrading a firmware component of computing node 102, computing node 102 may be configured to not join a plurality of other computing nodes. In some examples, the plurality of computing nodes and/or computing node 102 may be a cluster of nodes. In some examples, upon completion of upgrading a firmware component of computing node 102, computing node 102 may be configured to not join a cluster of other nodes, nor become a single-node cluster. In some examples, computing node 102 may not join a cluster after upgrading its firmware and/or software components.

In this way, computing node 102, by way of upgrade device 112 (in some examples), is capable of, and is configured to, performing self-upgrading operations. Upgrading one or more firmware and/or software components on one or more unconfigured nodes may refer to installation of one or more updated versions of firmware and/or software associated with and/or corresponding to one or more hardware components on the one or more unconfigured computing nodes. Such unconfigured nodes may include one or more virtual machines and/or containers that may contain an operating system. Accordingly, in some examples, the upgraded unconfigured computing nodes described herein may provide a virtualization environment, including one or more virtual machines, containers, or combinations thereof.

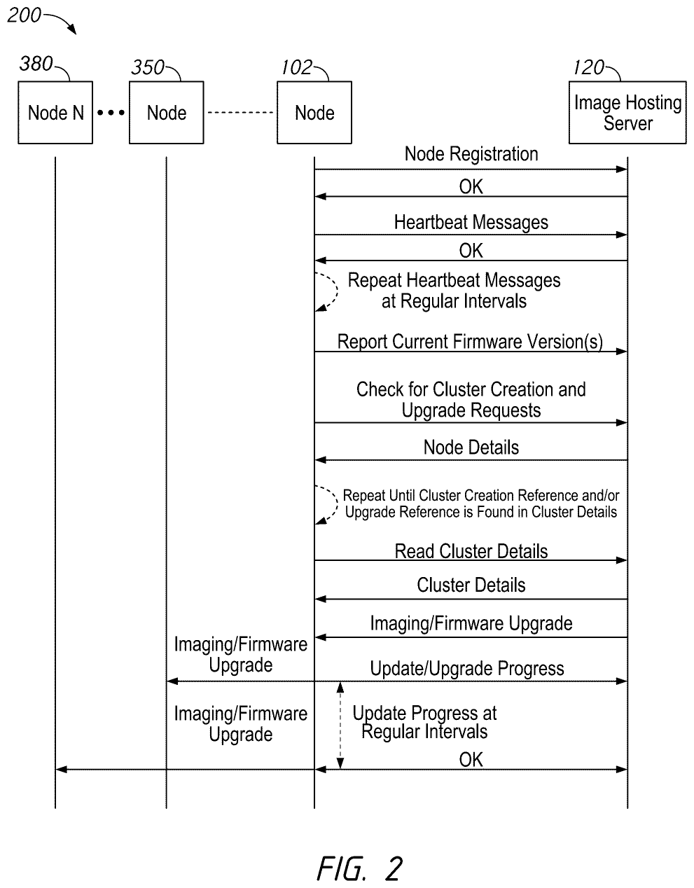

FIG. 2 depicts an example sequence diagram 200 for upgrading an unconfigured computing node, arranged in accordance with examples described herein. As described with respect to FIG. 1, computing node 102 (e.g., an unconfigured computing node) may provide a node registration to a server, such as image hosting server 120. In some examples, image hosting server 120 may provide confirmation of node registration back to computing node 102. Computing node 102 may provide heartbeat messages to image hosting server 120. Image hosting server 120 may provide confirmation of the heartbeat messages back to computing node 102. In some examples, computing node 102 may send heartbeat messages to image hosting server 120 at one or more time intervals. As one example, computing node 102 may send heartbeat messages to image hosting server 120 every 10 minutes. Each heartbeat message may include a timestamp, a node identifier (e.g., an unconfigured node identifier), and/or a node status indicator (e.g., an unconfigured node status indicator). The heartbeat message may be implemented as data, which may be provided to the image hosting server 120 over a wired or wireless network. In some examples, the heartbeat messages may include information letting a server (e.g., image hosting server 120) know that the node (e.g., computing node 102) is up and running, and connected to the server. In some examples, the heartbeat messages may act as a type of “liveness” check. In some examples, the heartbeat messages may occur at any time/any time-based interval based on the implementation and response. In some examples, the heartbeat messages may also be used to send additional details of an unconfigured node (e.g., computing node 102), such as, for example, health status to the server.

In some examples, computing node 102 may send cluster creation and/or upgrade requests to image hosting server 120. In some examples, these requests by computing node 102 to image hosting server 120 may include requests asking whether any cluster creation and/or upgrade requests are available. In some examples, if one or more cluster creation requests and/or upgrade requests are available at image hosting server 120, they will be fetched (by computing node 102) from imaging hosting server 120. In some examples, such requests may be one-directional. In some examples, such requests may not be one directional (e.g., polling). For example, in some examples, a server, such as image hosting server 120, may send a request (e.g., directly) to computing node 102. In some examples, image hosting server 120, may send a request directly to computing node 102 if required. Image hosting server 120 may provide node details back to computing node 102. In some examples, the node details provided back to computing node 102 from image hosting server 120 may include one or more indications of the existence of an upgrade for one or more firmware components and/or software components of computing node 102. In some examples, computing node 102 may iteratively send cluster creation and/or upgrade requests to image hosting server 120, and may iteratively receive node details from image hosting server 120 until a cluster reference is found within the node details, in some examples. As should be appreciated, while, in response to computing node 102 sending a “check for cluster creation and upgrade requests,” image hosting server 120 send back to computing node 102 node details, and while it is shown that his may be repeated, there may be additional and/or alternative implementations of this step that are contemplated to be within the scope of this disclosure.

In some examples, image hosting server 120 may then provide to computing node 102 an image of an upgrade for one or more firmware and/or software components of computing node 102. In some examples, image hosting server 120 may monitor the progress of the upgrades. In some examples, computing node 102 will provide to image hosting server 120 update and/or upgrade progress information and/or data. In some examples, computing node 102 will provide to image hosting server 120 update and/or upgrade progress information and/or data at various time intervals, such as, for example, every 30 seconds. In some examples, image hosting server 120 will confirm receipt of update and/or upgrade progress information and/or data to computing node 102. In some examples, a similar process may occur between additional and/or alternative unconfigured computing nodes, such as computing node 350 of FIG. 2 and/or computing node 380 of FIG. 2.

In these examples, image hosting server 120 may provide an upgrade image for one or more firmware and/or software components of computing node 350 and/or computing node 380. The progress of the upgrade operations may be monitored by image hosting server 120, and computing node 350 and/or computing node 380 may iteratively send update and/or upgrade progress information and/or data to image hosting server 120. In some examples, image hosting server 120 may perform health checks on computing node 102, computing node 350, and/or computing node 352 prior to, during, and/or after performance of the upgrade operations described herein. In some examples, the upgrade of computing node 102, computing node 350, and/or computing node 380 may be performed in parallel. In some examples, the upgrade of computing node 102, computing node 350, and/or computing node 380 may not be performed in parallel. In some examples, the upgrade of computing node 102, computing node 350, and/or computing node 380 may each be performed independently of each other.

The sequence diagram 200 of FIG. 2 is exemplary, and it should be appreciated that one or more additional and/or alternative implementations described herein may be utilized to perform the upgrade of one or more firmware and/or software components of one or more unconfigured computing nodes, without departing from the scope of this disclosure.

FIG. 3 is a schematic illustration of a distributed computing system 300 including an unconfigured computing node that has been upgraded and is part of a single-node cluster, arranged in accordance with examples described herein. The distributed computing system 300 may include elements and/or processes that have been previously described with respect to the system 100 of FIG. 1 and/or sequence diagram 200 for upgrading an unconfigured computing node of FIG. 2. Those elements that have been identified in FIG. 3 using the same reference numbers used in FIG. 1 and FIG. 2, and operation of the common elements, is as previously described. Consequently, a detailed description of the operation of these particular elements will not be repeated in the interest of brevity.

As described herein, distributed computing system 300 of FIG. 3 generally includes a computing node 102, image hosting server 120 (e.g., location that contains upgrade information, cluster information, address information, etc.), and storage pool 312 connected to a network 318. The network 318 may be any type of network capable of routing data transmissions from one network device (e.g., computing node 102, storage pool 312) to another. For example, the network 318 may be a local area network (LAN), wide area network (WAN), intranet, Internet, or a combination thereof. The network 318 may be a wired network, a wireless network, or a combination thereof. Although not shown, computing node 102 generally includes a processor, memory (e.g., non-transitory computer-readable storage medium), and executable instructions stored on the memory that, when executed by, for example, one or more components of computing node 102 of FIG. 3, cause the computing node 102 to perform one or more operations.

Storage pool 312 may include local storage 110, cloud storage 314, and networked storage 316. The local storage 110 may include, for example, one or more solid state drives (SSD 116) and one or more hard disk drives (HDD 118). Local storage 110 may be directly coupled to, included in, and/or accessible by a respective computing node 102 without communicating via the network 318. Cloud storage 314 may include one or more storage servers that may be stored remotely to the computing node 102 and accessed via the network 318. The cloud storage 314 may generally include any type of storage device, such as HDDs, SSDs, or optical drives. Networked storage 316 may include one or more storage devices coupled to and accessed via the network 318. The networked storage 316 may generally include any type of storage device, such as HDDs, SSDs, or optical drives. In various embodiments, the networked storage 316 may be a storage area network (SAN). The computing node 102 is a computing device for hosting VMs in the distributed computing system 300 of FIG. 3. The computing node 102 may be, for example and as described herein, a server computer, a laptop computer, a desktop computer, a tablet computer, a smart phone, or any other type of computing device. The computing node 102 may include one or more physical computing components, such as processors and/or memory, such as non-transitory computer-readable storage media.

Recall that FIG. 3 is a schematic illustration of a distributed computing system 300 including an unconfigured computing node that has been upgraded and is part of a single-node cluster. Unlike computing node 102 of FIG. 1, one or more firmware components and/or one or more software components of computing node 102 of FIG. 3 have been upgraded, such as by using one or more upgrade images obtained by a server, in some examples, such as image hosting server 120 of FIG. 3 and image hosting server 120 of FIG. 1.

Similar to computing node 102 of FIG. 1 and/or computing node 102 of FIG. 2, while one or more firmware components and/or software components of computing node 102 of FIG. 3 is depicted as already being upgraded, computing node 102 of FIG. 3 may be configured to, by executing instructions, monitor the status of additional upgrade operations (e.g., the accessing, identifying, obtaining, imaging, etc.). In some examples, computing node 102 of FIG. 3 may be configured to, by executing instructions, provide (via a display, such as display 620 of FIG. 6) a graphical user interface (GUI) corresponding to and/or associated with the status of the additional upgrade operations, including current upgrade operations as well as future upgrade operations as they occur. In some examples, computing node 102 of FIG. 3 may be configured to, by executing instructions, provide health check status information to a server, such as image hosting server 120 of FIG. 3.

FIG. 4 is a schematic illustration of a distributed computing system 400 including an unconfigured computing node that has been upgraded and is part of a multi-node cluster, arranged in accordance with examples described herein. The distributed computing system 400 may include elements that have been previously described with respect to the system 100 of FIG. 1, sequence diagram 200 for upgrading an unconfigured computing node of FIG. 2, and/or distributed computing system 300 of FIG. 3. Those elements have been identified in FIG. 4 using the same reference numbers used in FIGS. 1-3, and operation of the common elements is as previously described. Consequently, a detailed description of the operation of these particular elements will not be repeated in the interest of brevity.

As described herein, distributed computing system 400 of FIG. 4 generally includes a computing node 102, computing node 350, image hosting server 120 (e.g., location that contains upgrade information, cluster information, address information, etc.), and storage pool 312 connected to a network 318. As described herein, network 318 may be any type of network capable of routing data transmissions from one network device (e.g., computing node 102, computing node 350, storage pool 312, etc.) to another. For example, the network 318 may be a local area network (LAN), wide area network (WAN), intranet, Internet, or a combination thereof. The network 318 may be a wired network, a wireless network, or a combination thereof. Although not shown, computing node 102 and/or computing node 350 each generally includes a processor, memory (e.g., non-transitory computer-readable storage medium), and executable instructions stored on the memory that, when executed by, for example, one or more components of computing node 102 and/or computing node 350, cause the computing node 102 and/or computing node 350 to perform one or more operations.

As described above, storage pool 312 may include local storage 110, local storage 360, cloud storage 314, and networked storage 316. The local storage 110 and/or local storage 360 may include, for example, one or more solid state drives (SSD 116, SSD 362) and one or more hard disk drives (HDD 118, HDD 364). Local storage 110 may be directly coupled to, included in, and/or accessible by a respective computing node 102 without communicating via the network 318. Local storage 360 may also be directly coupled to, included in, and/or accessible by a respective computing node 350 without communicating via the network 318. Cloud storage 314 may include one or more storage servers that may be stored remotely to the computing node 102 and/or computing node 350 and accessed via the network 318. The cloud storage 314 may generally include any type of storage device, such as HDDs SSDs, or optical drives. Networked storage 316 may include one or more storage devices coupled to and accessed via the network 318. The networked storage 316 may generally include any type of storage device, such as HDDs, SSDs, or optical drives. In various embodiments, the networked storage 316 may be a storage area network (SAN). Computing node 102 may be a computing device for hosting VMs in the distributed computing system 400 of FIG. 4. Computing node 350 may be a computing device for hosting VMs in the distributed computing system 400 of FIG. 4. Computing node 102 and/or computing nodes 350 may each be, for example, a server computer, a laptop computer, a desktop computer, a tablet computer, a smart phone, or any other type of computing device. Computing node 102 and/or computing node 350 may include one or more physical computing components, such as processors and/or memory, such as non-transitory computer-readable storage media.

Recall that FIG. 4 is a schematic illustration of a distributed computing system 400 including an unconfigured computing node that has been upgraded and is part of a multi-node cluster. Unlike computing node 102 of FIG. 1, one or more firmware components and/or one or more software components of computing node 102 of FIG. 4 have been upgraded, such as by using one or more upgrade images obtained by a server, in some examples, such as image hosting server 120 of FIG. 4 and image hosting server 120 of FIG. 1. While the upgrade process for computing node 350 is not described herein as it is for computing node 102, it should be appreciated that computing node 350 (and/or additional and/or alternative unconfigured computing nodes not shown in FIG. 4) may be configured for upgrading. It should further be appreciated that computing node 350 (and/or additional and/or alternative unconfigured computing nodes not shown in FIG. 4) may be configured to be upgraded using the assistance of a coordinating node, an orchestrator, a standalone virtual machine, or the like. It should further be appreciated that computing node 350 (and/or some of the additional and/or alternative unconfigured computing nodes not shown in FIG. 4) may be configured for upgrading using the assistance of a server, such as image hosting server 120 of FIGS. 1, 2, 3, and/or 4.

As should be appreciated, FIGS. 1-4 are schematic illustrations arranged in accordance with examples described herein. It should be appreciated that FIGS. 1-4 provide only an illustration of one implementation and does not imply any limitations with regard to the environments in which different embodiments may be implemented. Many modifications to the depicted environment may be made. The computing node 102 may implemented as at least part of the unconfigured node upgrade system 100 and sequence diagram 200 of FIGS. 1 and 2, respectively, and/or implemented as at least a part of the distributed computing systems 300 and 400 of FIGS. 3 and 4 (or any other computing device or part of any other system described herein).

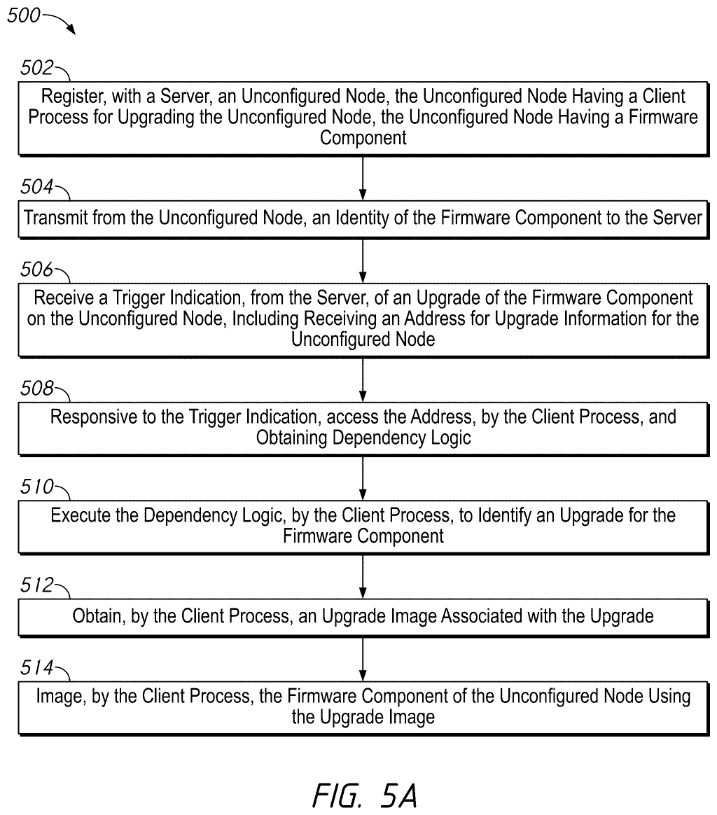

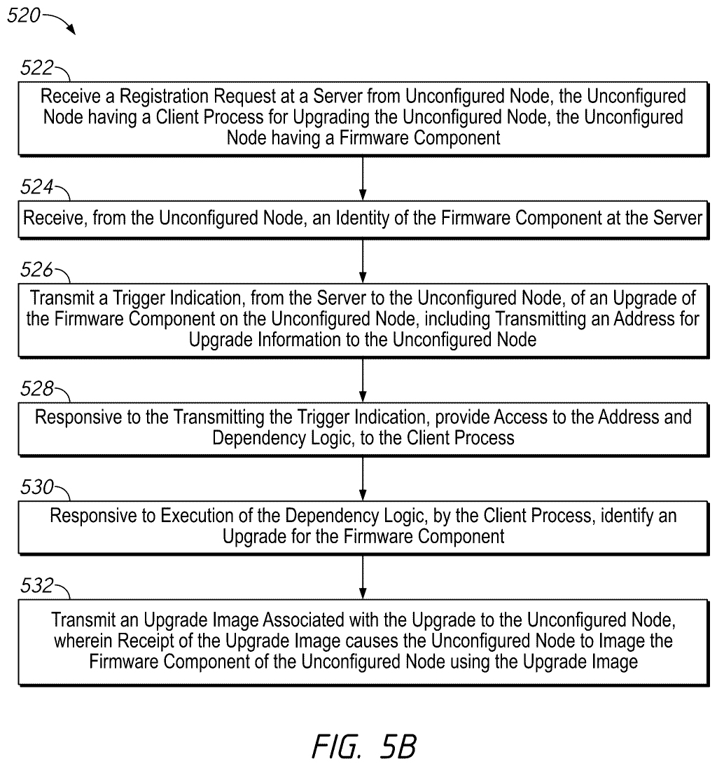

FIG. 5A is a flow diagram of a method 500 for upgrading an unconfigured computing node, arranged in accordance with examples described herein.

The method 500 includes registering, with a server, an unconfigured node, the unconfigured node having a client process for upgrading the unconfigured node, the unconfigured node having a firmware component in block 502; transmitting, from the unconfigured node, an identity of the firmware component to the server in block 504; receiving a trigger indication, from the server, of an upgrade of the firmware component on the unconfigured node, including receiving an address for upgrade information for the unconfigured node in block 506; responsive to the trigger indication, accessing the address, by the client process, and obtaining dependency logic in block 508; executing the dependency logic, by the client process, to identify an upgrade for the firmware component in block 510; obtaining, by the client process, an upgrade image associated with the upgrade in block 512; and imaging, by the client process, the firmware component of the unconfigured node using the upgrade image in block 514.

Block 502 recites registering, with a server, an unconfigured node, the unconfigured node having a client process for upgrading the unconfigured node, the unconfigured node having a firmware component.

Block 504 recites transmitting, from the unconfigured node, an identity of the firmware component to the server.

Block 506 recites receiving a trigger indication, from the server, of an upgrade of the firmware component on the unconfigured node, including receiving an address for upgrade information for the unconfigured node.

Block 508 recites responsive to the trigger indication, accessing the address, by the client process, and obtaining dependency logic.

Block 510 recites executing the dependency logic, by the client process, to identify an upgrade for the firmware component.

Block 512 recites obtaining, by the client process, an upgrade image associated with the upgrade.

Block 514 recites imaging, by the client process, the firmware component of the unconfigured node using the upgrade image.

In some examples, any of the registering operations at block 502, transmitting operations at block 504, receiving operations in block 506, accessing and obtaining operations in block 508, executing and identifying operations in block 510, obtaining operations in block 512, and/or the imaging operations in block 514 may be considered upgrade operations.

In some examples, the status of the upgrade operations may be monitored using an application programming interface (API). In some examples, the API may be a REST API. In some examples, the API may be an RPC API. In some examples, the API may be a GraphQL API. In some examples, the API may be a combination of any of the API's described herein. As should be appreciated, the API used for monitoring the upgrade operations may be an additional and/or alternative API to those listed herein, each of which is considered to be within the scope of this disclosure.

In some examples, a graphical user interface (GUI) corresponding to and/or associated with the status of the upgrade operations may be provided. In some examples, the status may comprise one or more progress updates associated with the upgrade operations. In some examples, the progress updates may be stored and/or presented in a log, such as an event log. In some examples, the one or more progress updates are stored on one or more files (e.g., log files, etc.) that may be accessible via the API of the bootstrapping environment. In some examples, one or more log files may comprise the one or more progress updates, and may be included in the event log.

In some examples, computing node 102 may provide health information to a server, such as image hosting server 120. In some examples, image hosting server 120 may perform the health check on computing node 102. In some examples, the health check may be performed after computing node 102 registers with image hosting server 120. In some examples, the health check may be performed prior to upgrading one or more firmware and/or software components of computing node 102. In some examples, the health check may be performed during the upgrading process of one or more firmware and/or software components of computing node 102. In some examples, the health check may be performed after upgrading one or more firmware and/or software components of computing node 102.

In some examples, a second unconfigured computing node may be configured to upgrade one or more firmware components and/or one or more software components of the second unconfigured node, as described herein.

In some examples, computing node 102 may be configured to upgrade itself with the upgrade image independently from the upgrading of one or more other nodes (such as the second unconfigured node) via one or more other upgrade images, and by the one or more other nodes (e.g., one or more other unconfigured nodes). In some examples, the upgrading of the second firmware component of the second unconfigured node using the second upgrade image (not shown in FIG. 1), and the upgrading of the computing node 102 (e.g., the unconfigured computing node) using the upgrade image, may be performed in parallel. In some examples, the parallel upgrade of computing node 102 and the second unconfigured computing node may be self-performed by each unconfigured computing node, respectively.

In some examples, upon completion of upgrading a firmware component of computing node 102, computing node 102 may be configured to join a single-node cluster, where the single node is the recently upgraded computing node 102. In some examples, upon completion of upgrading a firmware component of computing node 102, computing node 102 may be configured to not join a plurality of other computing nodes. In some examples, the plurality of computing nodes and/or computing node 102 may be a cluster of nodes.

In some examples, upon completion of upgrading a second firmware component of a second unconfigured computing node, the second unconfigured computing node may be configured to join a single-node cluster, where the single computing node is the recently upgraded second unconfigured computing node. In some examples, upon completion of upgrading a firmware component of the second unconfigured computing node, the second unconfigured computing node may be configured to not join a plurality of other computing nodes. In some examples, the plurality of computing nodes and/or the second unconfigured computing node and/or computing node 102 may be a cluster of nodes.

In this way, examples described herein facilitate and/or enable imaging of an unconfigured node (e.g., a remote node or a node that has yet to be joined to a cluster and/or a plurality of nodes) without the assistance of a coordinating node, an orchestrator, a standalone virtual machine, or the like. Further, examples herein describe the unique way in which unconfigured nodes (e.g., remote nodes, computing nodes, nodes deployed at a remote location, nodes deployed non-locally, nodes yet-to-be deployed, etc.) can be upgraded without additional infrastructure at the remote (e.g., customer) site (e.g., location), by enabling the unconfigured node to register itself, access a server, locate an upgrade image address, obtain an upgrade image, and upgrade itself. As described throughout, examples described herein further facilitate and/or enable monitoring of the upgrading operations during the upgrade process, as well as health checks performed prior, during, and after the upgrade operations.

FIG. 5B is a flow diagram of a method 520 for upgrading an unconfigured computing node (e.g., an unconfigured computing node), arranged in accordance with examples described herein.

The method 520 includes receiving a registration request at a server from unconfigured node, the unconfigured node having a client process for upgrading the unconfigured node, the unconfigured node having a firmware component in block 522; receiving, from the unconfigured node, an identity of the firmware component at the server in block 524; transmitting, from the server to the unconfigured node, a trigger indication of an upgrade of the firmware component on the unconfigured node, including transmitting an address for upgrade information to the unconfigured node in block 526; responsive to transmitting the trigger indication, providing access to the address and dependency logic to the client process in block 528; responsive to execution of the dependency logic, by the client process, identifying an upgrade for the firmware component in block 530; and transmitting an upgrade image associated with the upgrade to the unconfigured node, wherein receipt of the upgrade image causes the unconfigured node to image the firmware component of the unconfigured node using the upgrade image in block 532.

Block 522 recites receiving a registration request at a server from unconfigured node, the unconfigured node having a client process for upgrading the unconfigured node, the unconfigured node having a firmware component.

Block 524 recites receiving, from the unconfigured node, an identity of the firmware component at the server.

Block 526 recites transmitting, from the server to the unconfigured node, a trigger indication of an upgrade of the firmware component on the unconfigured node, including transmitting an address for upgrade information to the unconfigured node.

Block 528 recites responsive to transmitting the trigger indication, providing access to the address and dependency logic to the client process.

Block 530 recites responsive to execution of the dependency logic, by the client process, identifying an upgrade for the firmware component.

Block 532 recites transmitting an upgrade image associated with the upgrade to the unconfigured node, wherein receipt of the upgrade image causes the unconfigured node to image the firmware component of the unconfigured node using the upgrade image.

In some examples, an unconfigured node, such as computing node 102 of FIG. 1, may be configured to receive an intent to create a cluster of nodes from a server, such as image hosting server 120 of FIG. 1. In some examples, an unconfigured node, such as computing node 102 of FIG. 1, may be configured to receive an intent to join a cluster of nodes from a server, such as image hosting server 120 of FIG. 1. In some examples, computing node 102 may be configured to receive an intent to upgrade a firmware component and/or a software component of computing node 102 from a server, such as image hosting server 120 of FIG. 1. In some examples, additionally and/or alternatively, an unconfigured node, such as computing node 102 of FIG. 1, may be configured to receive an intent that may include imaging. In some examples, the intent may exclusively include imaging. In some examples, the intent may include imaging as well as cluster creation.

In this way, and as described throughout, examples described herein facilitate and/or enable imaging of an unconfigured node (e.g., a remote node or a node that has yet to be joined to a cluster and/or a plurality of nodes) without the assistance of a coordinating node, an orchestrator, a standalone virtual machine, or the like. Further, examples herein describe the unique way in which unconfigured nodes (e.g., remote nodes, computing nodes, nodes deployed at a remote location, nodes deployed non-locally, nodes yet-to-be deployed, etc.) can be upgraded without additional infrastructure at the remote (e.g., customer, user, administrator, etc.) site (e.g., location), by enabling the unconfigured node to register itself, access a server, locate an upgrade image address, obtain an upgrade image, and upgrade itself. As described throughout, examples described herein further facilitate and/or enable monitoring of the upgrading operations during the upgrade process, as well as health checks performed prior to, during, and/or after the upgrade operations.

FIG. 6 depicts a block diagram of components of a computing node 600 in accordance with an embodiment of the present disclosure. It should be appreciated that FIG. 6 provides only an illustration of one implementation and does not imply any limitations with regard to the environments in which different embodiments may be implemented. Many modifications to the depicted environment may be made. The computing node 600 may be implemented as any of the computing nodes 102 of FIGS. 1-4 and/or computing node 350 of FIGS. 2 and 4 and/or computing node computing node 380 of FIG. 2. The computing node 600 may be configured to implement the unconfigured computing node upgrade method 500 of FIG. 5A and/or the unconfigured computing node upgrade method 520 of FIG. 5B, to upgrade one or more firmware and/or software components of computing node 600 via communication with a server, such as image hosting server 120 of FIG. 1.

The computing node 600 includes a communications fabric 602, which provides communications between one or more processor(s) 604, memory 606, local storage 608, communications unit 610, and I/O interface(s) 612. The communications fabric 602 can be implemented with any architecture designed for passing data and/or control information between processors (such as microprocessors, communications and network processors, etc.), system memory, peripheral devices, and any other hardware components within a system. For example, the communications fabric 602 can be implemented with one or more buses.

The memory 606 and the local storage 608 are computer-readable storage media. In this embodiment, the memory 606 includes random access memory (RAM) 614 and cache 616. In general, the memory 606 can include any suitable volatile or non-volatile computer-readable storage media. The local storage 608 may be implemented as described above with respect to local storage 110 of FIGS. 1, 3 and 4. In this embodiment, the local storage 608 includes an SSD 622 and an HDD 624, which may be implemented as described above with respect to SSDs 116 and HDDs 118 of FIGS. 1, 3 and 4.

Various computer instructions, programs, files, images, etc., may be stored in local storage 608 for execution by one or more of the respective processor(s) 604 via one or more memories of memory 606. In some examples, local storage 608 includes a magnetic HDD 624. Alternatively, or in addition to a magnetic hard disk drive, local storage 608 can include the SSD 622, a semiconductor storage device, a read-only memory (ROM), an erasable programmable read-only memory (EPROM), a flash memory, or any other computer-readable storage media that is capable of storing program instructions or digital information.

The media used by local storage 608 may also be removable. For example, a removable hard drive may be used for local storage 608. Other examples include optical and magnetic disks, thumb drives, and smart cards that are inserted into a drive for transfer onto another computer-readable storage medium that is also part of local storage 608.

Communications unit 610, in these examples, provides for communications with other data processing systems or devices. In these examples, communications unit 610 includes one or more network interface cards. Communications unit 610 may provide communications through the use of either or both physical and wireless communications links.

I/O interface(s) 612 allows for input and output of data with other devices that may be connected to computing node 600. For example, I/O interface(s) 612 may provide a connection to external device(s) (not shown) such as a keyboard, a keypad, a touch screen, and/or some other suitable input device. External device(s) 618 (not shown) can also include portable computer-readable storage media such as, for example, thumb drives, portable optical or magnetic disks, and memory cards. Software and data used to practice embodiments of the present disclosure can be stored on such portable computer-readable storage media and can be loaded onto local storage 608 via I/O interface(s) 612. I/O interface(s) 612 may also connect to a display 620.

Display 620 provides a mechanism to display data to a user, client, administrator, etc., and may be, for example, a computer monitor.

Various features described herein may be implemented in hardware, software executed by a processor, firmware, or any combination thereof. If implemented in software (e.g., in the case of the methods described herein), the functions may be stored on or transmitted over, as one or more instructions or code, a computer-readable medium. Computer-readable media includes both non-transitory computer storage media and communication media including any medium that facilitates transfer of a computer program from one place to another. A non-transitory storage medium may be any available medium that can be accessed by a general-purpose or special-purpose computer. By way of example, and not limitation, non-transitory computer-readable media can comprise RAM, ROM, electrically erasable programmable read-only memory (EEPROM), or optical disk storage, magnetic disk storage, or other magnetic storage devices, or any other non-transitory medium that can be used to carry or store desired program code means in the form of instructions or data structures and that can be accessed by a general-purpose or special-purpose computer, or a general-purpose or special-purpose processor.

From the foregoing, it will be appreciated that, although specific embodiments of the disclosure have been described herein for purposes of illustration, various modifications may be made without deviating from the spirit and scope of the disclosure. Thus, the disclosure is not limited to the examples and designs described herein except as by the appended claims, and is to be accorded the broadest scope consistent with the principles and novel features disclosed herein.

What is claimed is:

1. A method comprising:
registering, with a server, an unconfigured node having a client process for self-upgrading and a firmware component;
transmitting, from the unconfigured node, an identity of the firmware component to the server;
receiving a trigger indication, from the server, of an upgrade for the firmware component including receiving an address;
responsive to the trigger indication, accessing the address, by the client process, and obtaining dependency logic;
executing the dependency logic, by the client process, to identify an upgrade for the firmware component and an upgrade image associated with the upgrade; and
imaging, by the client process, the firmware component of the unconfigured node using the upgrade image.

2. The method of claim 1, wherein the imaging of the firmware component of the unconfigured node using the upgrade image is performed using an in-band communication mechanism.

3. The method of claim 2, wherein the in-band communication mechanism comprises communicating through a virtual network interface card (vNIC).

4. The method of claim 1, further comprising:
joining, based at least on imaging the firmware component of the unconfigured node using the upgrade image, the unconfigured node to a plurality of nodes, the plurality of nodes comprising one or more other nodes.

5. The method of claim 1, wherein the firmware component of the unconfigured node is associated with a hardware component of the unconfigured node, and wherein the upgrade for the firmware component corresponds to an upgrade for the hardware component.

6. The method of claim 4, wherein the imaging of the firmware component of the unconfigured node using the upgrade image is independent from imaging firmware on the one or more other nodes, independent from imaging software on the one or more other nodes, or a combination thereof.

7. The method of claim 1, wherein the unconfigured node is a remote node.

8. The method of claim 1, further comprising receiving, at the unconfigured node, an intent to create a cluster of nodes from the server.

9. The method of claim 1, further comprising receiving, at the unconfigured node, an intent to join a cluster of nodes from the server.

10. The method of claim 1, further comprising:
registering, with the server, a second unconfigured node, the second unconfigured node having a second client process for upgrading the second unconfigured node, the second unconfigured node having a second firmware component;
transmitting, from the second unconfigured node, an identity of the second firmware component to the server;
receiving, from the server, a second trigger indication of a second upgrade of the second firmware component on the second unconfigured node, including receiving a second address for second upgrade information for the second unconfigured node;
responsive to the second trigger indication, accessing the second address, by the second client process, and obtaining second dependency logic;
executing the second dependency logic, by the second client process, to identify the second upgrade for the second firmware component;
obtaining, by the second client process, a second upgrade image associated with the second upgrade; and
imaging, by the second client process, the second firmware component of the second unconfigured node using the second upgrade image.

11. The method of claim 10, wherein the imaging of the second firmware component of the second unconfigured node and the imaging of the firmware component of the unconfigured node is performed in parallel.

12. The method of claim 10, wherein the imaging of the second firmware component of the second unconfigured node is independent from the imaging of the firmware component of the unconfigured node.

13. The method of claim 1, further comprising:
performing, by the server, and based at least on the registering of the unconfigured node with the server, a health check on the unconfigured node.

14. A system comprising:
a server; and
an unconfigured node having a client process for self-upgrading and a firmware component, and the unconfigured node comprising at least one processor and memory storing instructions which, when executed by the at least one processor, cause the unconfigured node to perform operations comprising:
register the unconfigured node with the server;
transmit an identity of the firmware component to the server;
receive, from the server, a trigger indication of an upgrade for the firmware component, the trigger indication comprising an address;
access, by the client process and in response to receipt of the trigger indication, the address to obtain dependency logic;
identify the upgrade for the firmware component and an upgrade image associated with the upgrade based at least in part on executing, by the client process, the dependency logic; and
image, by the client process, the firmware component of the unconfigured node using the upgrade image.

15. The system of claim 14, wherein the unconfigured node is further configured to:
image the firmware component using the upgrade image using an in-band communication mechanism.

16. The system of claim 15, wherein the in-band communication mechanism comprises communicating through a virtual network interface card (vNIC).

17. The system of claim 14, wherein the unconfigured node is further configured to:
join a plurality of nodes including one or more other nodes, based at least on the imaging of the firmware component of the unconfigured node using the upgrade image.

18. The system of claim 14, wherein the firmware component of the unconfigured node is associated with a hardware component of the unconfigured node, and wherein the upgrade for the firmware component corresponds to an upgrade for the hardware component.

19. The system of claim 17, wherein imaging the firmware component of the unconfigured node using the upgrade image is independent from the imaging of firmware on the one or more other nodes, independent from imaging software on the one or more other nodes, or a combination thereof.

20. The system of claim 14, wherein the unconfigured node is a remote node.

21. The system of claim 14, wherein the unconfigured node is further configured to receive an intent to create a cluster of nodes from the server, an intent to join a cluster of nodes from the server, or a combination thereof.

22. The system of claim 14, further comprising a second unconfigured node having a second client process for upgrading the second unconfigured node and a second firmware component, the second unconfigured node configured to:
register with the server;
transmit an identity of the second firmware component to the server;
receive a second trigger indication of a second upgrade of the second firmware component on the second unconfigured node from the server, including receiving a second address for second upgrade information for the second unconfigured node;
access the second address, by the second client process, responsive to the second trigger indication;
obtain second dependency logic;
execute the second dependency logic, by the second client process, to identify a second upgrade for the second firmware component;
obtain, by the second client process, a second upgrade image associated with the second upgrade; and
image, by the second client process, the second firmware component of the second unconfigured node using the second upgrade image.

23. The system of claim 22, wherein the imaging of the second firmware component by the second unconfigured node and the imaging of the firmware component by the unconfigured node are performed in parallel.

24. The system of claim 22, wherein the imaging of the second firmware component by the second unconfigured node is independent from the imaging of the firmware component by the unconfigured node.

25. The system of claim 22, wherein the server is further configured to:
perform a health check on the unconfigured node based at least on the registering of the unconfigured node with the server and prior to transmitting the trigger indication of the upgrade to the unconfigured node; and
perform a health check on the second unconfigured node based at least on the registering of the second unconfigured node with the server and prior to transmitting the second trigger indication of the second upgrade to the second unconfigured node.

26. At least one non-transitory computer-readable storage medium including instructions that, when executed by one or more processors, cause the one or more processors to perform operations comprising:
receiving a registration request at a server from an unconfigured node having a client process for self-upgrading and a firmware component;
receiving, from the unconfigured node, an identity of the firmware component at the server;
transmitting, from the server to the unconfigured node, a trigger indication of an upgrade for the firmware component, including transmitting an address;
responsive to transmitting the trigger indication, providing access to the address and dependency logic to the client process;
responsive to execution of the dependency logic, by the client process, identifying an upgrade for the firmware component and an upgrade image associated with the upgrade; and
transmitting the upgrade image to the unconfigured node, wherein receipt of the upgrade image causes the unconfigured node to image the firmware component of the unconfigured node using the upgrade image.

27. The at least one non-transitory computer-readable storage medium of claim 26, wherein the imaging of the firmware component of the unconfigured node using the upgrade image is performed using an in-band communication mechanism.

28. The at least one non-transitory computer-readable storage medium of claim 27, wherein the in-band communication mechanism comprises communicating through a virtual network interface card (vNIC).

29. The at least one non-transitory computer-readable storage medium of claim 26, wherein the instructions, when executed, further cause the one or more processors to perform operations comprising:
joining, by the unconfigured node and based at least on imaging the firmware component of the unconfigured node using the upgrade image, the unconfigured node to a plurality of nodes, the plurality of nodes comprising one or more other nodes.

30. The at least one non-transitory computer-readable storage medium of claim 26, wherein the firmware component of the unconfigured node is associated with a hardware component of the unconfigured node, and wherein the upgrade for the firmware component corresponds to an upgrade for the hardware component.

31. The at least one non-transitory computer-readable storage medium of claim 29, wherein the imaging of the firmware component of the unconfigured node using the upgrade image is independent from imaging firmware of the one or more other nodes, independent from imaging software on the one or more other nodes, or a combination thereof.

32. The at least one non-transitory computer-readable storage medium of claim 26, wherein the unconfigured node is a remote node.

33. The at least one non-transitory computer-readable storage medium of claim 26, wherein the instructions, when executed, further cause the one or more processors to perform operations comprising:
receiving, from the server and at the unconfigured node, an intent to create a cluster of nodes, an intent to join the cluster of nodes, or a combination thereof.

34. The at least one non-transitory computer-readable storage medium of claim 26, wherein the instructions, when executed, further cause the one or more processors to perform operations comprising:
receiving a second registration request at the server from a second unconfigured node, the second unconfigured node having a second client process for upgrading the second unconfigured node, the second unconfigured node having a second firmware component;
receiving, from the second unconfigured node, an identity of the second firmware component at the server;
transmitting, from the server, a second trigger indication of a second upgrade of the second firmware component on the second unconfigured node, including receiving a second address for second upgrade information to the second unconfigured node;
responsive to transmitting the second trigger indication, providing access to the second address and second dependency logic to the client process;
responsive to execution of the second dependency logic, by the second client process, identifying a second upgrade for the second firmware component;
transmitting a second upgrade image associated with the second upgrade to the second unconfigured node, wherein receipt of the second upgrade image causes the second unconfigured node to image the second firmware component of the second unconfigured node using the second upgrade image.

35. The at least one non-transitory computer-readable storage medium of claim 34, wherein the imaging of the second firmware component by the second unconfigured node and the imaging of the firmware component by the unconfigured node are performed in parallel.

36. The at least one non-transitory computer-readable storage medium of claim 34, wherein the imaging of the second firmware component by the second unconfigured node is independent from the imaging of the firmware component by the unconfigured node.

37. The at least one non-transitory computer-readable storage medium of claim 34, wherein the instructions, when executed, further cause the one or more processors to perform operations comprising:
perform, by the server, a health check on the unconfigured node based at least on receipt of the registration request from the unconfigured node and prior to transmitting the trigger indication of the upgrade to the unconfigured node; and
perform, by the server, a health check on the second unconfigured node based at least on receipt of the second registration request from the second unconfigured node and prior to transmitting the second trigger indication of the second upgrade to the second unconfigured node.
